(19) United States
(12) Patent Application Publication
(10) Pub. No.: US 2026/0043727 A1
(43) Pub. Date: Feb. 12, 2026

(54) FRICTION AND WEAR TEST SYSTEM AND FRICTION AND WEAR TEST METHOD

(71) Applicant: HENAN UNIVERSITY OF SCIENCE AND TECHNOLOGY, Henan (CN)

(72) Inventors: Donglin LI, Henan (CN); Fang YANG, Henan (CN); Junhua WANG, Henan (CN); Jianjun PENG, Henan (CN); Shuai WANG, Henan (CN); Yu WANG, Henan (CN); Xiaoqiang WANG, Henan (CN); Jubo LI, Henan (CN); Feng ZHAO, Henan (CN); Yinshui LIU, Henan (CN)

(73) Assignee: HENAN UNIVERSITY OF SCIENCE AND TECHNOLOGY, Henan (CN)

(21) Appl. No.: 19/257,408

(22) Filed: Jul. 1, 2025

(30) Foreign Application Priority Data
Aug. 9, 2024 (CN) 202411093968.3

(51) Int. Cl. G01N 3/56

(52) U.S. Cl. CPC G01N 3/56; G01N 2203/0411

(57) ABSTRACT

Disclosed are a friction and wear test system and a friction and wear test method. To reduce the error of measured friction coefficients, the friction and wear test system of the present disclosure includes a rotating shaft, a dynamic specimen mounting structure mounted on the rotating shaft, a first static specimen mounting structure, a first loading module for applying a preset loading force to the first static specimen during the test, and a second static specimen mounting structure arranged directly opposite to the first static specimen mounting structure in the axial direction of the rotating shaft. The second static specimen mounting structure is configured with a second loading module for applying a preset loading force pointing at the dynamic specimen to the second static specimen during the test, so as to at least partially counterbalance the force loaded on the dynamic specimen by the first static specimen during the test.

### CROSS-REFERENCE TO RELATED APPLICATION

This application claims the priority benefit of China application serial no. 202411093968.3, filed on Aug. 9, 2024. The entirety of the above-mentioned patent application is hereby incorporated by reference herein and made a part of this specification.

### BACKGROUND

### Field of the Disclosure

The present disclosure relates to the industry of measuring wear resistance characteristics of solid materials using mechanical stress, particularly relating to a friction and wear test system and a friction and wear test method.

### Description of Related Art

A hydraulic pump is the core component of a hydraulic system, with the overall performance of the hydraulic system primarily dependent on the performance of the hydraulic pump. The piston pump is a commonly used hydraulic pump in the practice of production. In daily production, the failure of friction pairs in piston pumps frequently occurs. In order to analyze the causes of friction pair failure, current technology generally employs simulation means for analysis; however, the results of such simulations are prone to distortion and cannot accurately guide the direction for improvement of the piston pump friction pairs.

To address the aforementioned issues, a Chinese patent for invention, with the publication number CN118032324B and publication date Jun. 14, 2024, discloses a friction and wear test method for multiple kinematic pairs in an axial piston pump. The test method utilizes a test apparatus that includes a horizontally extending rotating shaft driven by a rotary motor (equivalent to a rotating power source), a speed-torque sensor (equivalent to a detection device for measuring the torque of a rotating shaft) for measuring the torque of the rotating shaft, a three-jaw chuck (equivalent to a dynamic specimen mounting structure disposed on the rotating shaft for mounting dynamic specimens to rotate synchronously with the rotating shaft) connected to one end of the rotating shaft away from the rotary motor, a guide rail extending along the axial direction of the rotating shaft mounted on the frame, a mounting base that is in guided moving fit with the guide rail, a clamping mechanism (equivalent to a first static specimen mounting structure for mounting the first static specimen) disposed on the mounting base, a lubricating oil supply device connected to a lubricating oil supply pipe, a lubricating oil supply chamber fixed by the clamping mechanism and connected to the lubricating oil supply pipe (the lubricating oil supply device, lubricating oil supply pipe, and lubricating oil supply chamber are equivalent to a lubricating oil supply module), and a linear loading cylinder (equivalent to a first loading module that applies a predetermined backward loading force to the first static specimen during testing) for driving the mounting base to move axially along the rotating shaft.

When utilizing the above test device for testing, the three-jaw chuck is first utilized to grip the swash plate (equivalent to the dynamic specimen), and the clamping mechanism is utilized to fix the slipper (equivalent to the static specimen), and the lubricating oil supply chamber and the slipper are connected so that the lubricating oil supply chamber may supply lubricating oil to the slipper. Then, the linear loading cylinder is utilized to drive the mounting base to move toward the three-jaw chuck, thereby making the slipper press against the swash plate, and the linear loading cylinder applies a preset axial loading force to the slipper. Afterwards, lubricating oil is introduced into the lubricating oil supply pipe, so that the lubricating oil reaches the inside of the slipper through the lubricating oil supply chamber, and flows to the space between the slipper and the swash plate through the slipper, achieving lubrication between the slipper and the swash plate. Finally, the rotary motor is utilized to drive the rotating shaft to rotate, thereby making the rotating shaft drive the swash plate to rotate. Under the circumstances, a sliding friction occurs between the slipper and the swash plate, and after a period of time, the rotary motor may be turned off. Throughout the entire test process, the corresponding test data needs to be recorded.

In the meantime, a method for calculating the friction coefficient is disclosed in the above test method, the friction coefficient μ(ω) is calculated through the following formula:

$$μ ( ω ) = \frac{{M}_{f} - {M}_{0}}{{R}_{s} F} = \frac{{M}_{f}}{{R}_{s} F} - C$$

In the formula, F is an axial loading force applied by a linear loading cylinder; M_{f} is a torque of the rotating shaft measured by a speed-torque sensor; ω is a rotational speed of the rotating shaft; Rₛ is an equivalent friction radius of a friction pair; M₀ is a torque of the rotating shaft measured by the speed-torque sensor when an axial loading force F is 0; due to M₀, Rₛ and F are all constants, a constant C may be used to replace

$$\frac{{M}_{0}}{{R}_{s} F} .$$

However, in the above test device, since the linear loading cylinder applies a preset axial loading force to a slipper, the swash plate is fixed by the three-jaw chuck, and the slipper presses against an edge of the swash plate, an active force applied by the slipper to the swash plate will cause the swash plate to bend. Under circumstances, even if one side of the swash plate away from the slipper presses against the three-jaw chuck and applies the active force to the three-jaw chuck, a reaction force applied by the three-jaw chuck to the swash plate and the active force applied by the slipper to the swash plate cannot form a force couple relationship (if two forces act on the same straight line, and the magnitudes of the forces are equal and the directions are opposite, then these two forces are said to form a force couple relationship). That is, the reaction force applied by the three-jaw chuck to the swash plate cannot completely counterbalance the active force applied by the slipper to the swash plate, and the swash plate will still be subjected to a bending moment (i.e., still, the swash plate will be bent). When calculating the friction coefficient ρ(ω), if the swash plate is subjected to the bending moment, a difference between a torque M_{f} and an actual torque experienced by the swash plate is large, resulting in a significant error between the friction coefficient μ(ω) and an actual friction coefficient.

### SUMMARY OF THE DISCLOSURE

The purpose of the present disclosure is to provide a friction and wear test system to solve the technical problem of large errors when measuring the friction coefficient using the test device and the difficulty in accurately measuring the friction coefficient under different contact stress conditions in the related art.

The purpose of the present disclosure is also to provide a friction and wear test method to solve the same technical problem mentioned above.

To achieve the above purpose, the technical solution of the friction and wear test system provided by the present disclosure is as follows.

A friction and wear test system includes a rotating shaft, a dynamic specimen mounting structure disposed on the rotating shaft and used for mounting a dynamic specimen to make the dynamic specimen rotate with the rotating shaft, a first static specimen mounting structure for mounting the first static specimen, and a first loading module for applying a preset loading force pointing at the dynamic specimen to the first static specimen during a test. The friction and wear test system further includes a second static specimen mounting structure for mounting a second static specimen and arranged directly opposite to the first static specimen mounting structure in an axial direction of the rotating shaft. The second static specimen mounting structure is configured with a second loading module for applying a preset loading force pointing at the dynamic specimen to the second static specimen during the test, so as to at least partially counterbalance a force loaded by the first static specimen on the dynamic specimen during the test.

Furthermore, the rotating shaft extends horizontally in a front-rear direction, and magnitudes of the preset loading forces applied by the first loading module and the second loading module are the same.

Furthermore, the friction and wear test system includes a U-shaped base. The U-shaped base includes a connecting part and a first mounting part and a second mounting part located on both sides of the connecting part. A clearance space is formed between the first mounting part and the second mounting part for avoiding the dynamic specimen during use. The first static specimen mounting structure is a first piston bore disposed on the first mounting part and parallel to the rotating shaft. The second static specimen mounting structure is a second piston bore disposed on the second mounting part and parallel to the rotating shaft. A dimension of each piston bore is designed to match with a corresponding static specimen, so that each of the piston bore is in guided moving fit with the corresponding static specimen.

Furthermore, the first loading module includes a hydraulic station, a first piston chamber disposed on the first mounting part, a first loading piston located in the first piston chamber and used for pressing against the first static specimen, and a first loading pipeline connecting the hydraulic station with the first piston chamber. A connection point between the first loading pipeline and the first piston chamber is located on one side of the first loading piston away from the first piston bore.

Furthermore, the second loading module includes a second piston chamber disposed on a second mounting part, a second loading piston located in the second piston chamber and used for pressing against the second static specimen, and a second loading pipeline connecting the hydraulic station with the second piston chamber. A connection point between the second loading pipeline and the second piston chamber is located on one side of the second loading piston away from the second piston bore. The first loading module and the second loading module share one of the hydraulic station, and the first loading pipeline and the second loading pipeline are connected in parallel to the same hydraulic pipeline of the hydraulic station, or, the first loading module and the second loading module are each provided with one of the independent hydraulic station.

Furthermore, a hydraulic medium flowing in the hydraulic station and the corresponding loading pipeline is lubricating oil. The hydraulic station is connected with a lubricating oil supply pipeline. The U-shaped base is further provided with a lubricating oil supply channel. The lubricating oil supply channel includes a lubricating oil supply main line, a first lubricating oil supply branch line connected to the first piston bore and a second lubricating oil supply branch line connected to the second piston bore. Each lubricating oil supply branch line has an oil outlet connected to the corresponding piston bore. The lubricating oil supply pipeline is connected to a lubricating oil supply main line to supply lubricating oil with a preset pressure to each static specimen during the test. Each piston bore is provided with a first seal structure and a second seal structure adapted to the corresponding static specimen. Each of the oil outlet is located between the corresponding first seal structure and the corresponding second seal structure.

The advantageous effects of the friction and wear test system of the present disclosure are as follows. The present disclosure is an improved disclosure. During the test, the dynamic specimen mounting structure is utilized first to mount the dynamic specimen on the rotating shaft, and the first and second static specimen mounting structures are utilized to mount the first and second static specimens. Afterwards, the first loading module applies the loading force to the first static specimen, and the second loading module applies the loading force to the second static specimen. Since the first and second static specimen mounting structures are arranged directly opposite each other in the axial direction of the rotating shaft, and the loading forces applied by the first and second loading modules mutually counterbalance at least a portion thereof, it is possible to reduce the bending moment applied by the static specimens to the dynamic specimen. Therefore, the friction and wear test system in this technical solution may reduce the bending moment on the dynamic specimen, making the torque measured by the detection device more accurately reflect the actual torque of the dynamic specimen, thus reducing an error between the calculated friction coefficient and the actual friction coefficient.

To achieve the above purpose, the technical solution of the friction and wear test method provided by the present disclosure is as follows.

In a friction and wear test method, during a test, a rotating shaft is utilized to drive a dynamic specimen to rotate, and a first static specimen and a second static specimen that are directly opposite each other in an axial direction of the rotating shaft are utilized to clamp the dynamic specimen. The first static specimen is applied with a preset loading force F₁ pointing at the dynamic specimen by the first loading module. The second static specimen is applied with a preset loading force F₂ pointing at the dynamic specimen by the second loading module. The preset loading forces applied by the first and second loading modules mutually counterbalance at least a portion thereof.

When the rotating shaft extends horizontally, the friction coefficient is calculated as

$$μ = \frac{T}{R F} ,$$

where: T is a torque of the rotating shaft, F is a sum of contact forces between each static specimen and the dynamic specimen, R is a distance from a center of an annular friction surface where any of the static specimen contacts the dynamic specimen to an axis of the dynamic specimen.

When the rotating shaft does not extend horizontally, a friction coefficient is calculated as

$$μ = \frac{T - {T}_{0}}{R F} ,$$

where: T₀ is a torque of the rotating shaft measured by a speed-torque sensor when F is 0.

When conducting friction and wear tests under non-lubricated working conditions, F=F₁+F₂.

When conducting the friction and wear tests under non-lubricated working conditions, a lubricating oil supply module is utilized to provide lubricating oil with a preset pressure to the static specimen, F=F₁+F₂−F₃−F₄, where: F₃ and F₄ are forces applied to the static specimen by the lubricating oil located between each of the static specimen and the dynamic specimen.

Furthermore, the rotating shaft extends horizontally in a front-rear direction, and magnitudes of the preset loading forces applied by each loading module are the same. The pressures of the lubricating oil between each of the static specimen and the dynamic specimen are the same, so that

$${F}_{3} = {F}_{4} .$$

Furthermore, multiple tests are conducted using different specimens, and a wear rate w of each specimen is calculated,

$$w = \frac{2 Δ m}{ρ FnR} ,$$

where: Δm is a wear mass of each of the specimen, p is a density of each of the specimen, and n is the number of rotations of the dynamic specimen or the rotating shaft.

Furthermore, during the test, a contact stress between each of the static specimen and the dynamic specimen is calculated as

$$σ = \frac{F}{2 S} ,$$

where: S is an area of a friction surface where any static specimen contacts the dynamic specimen. The contact stress between the static specimen and the dynamic specimen may be changed by changing the static specimens with different areas of the friction surface, thereby testing the friction coefficient μ when the contact stress between the static specimen and the dynamic specimen is different.

The advantageous effects of the friction and wear test method of the present disclosure are: the present disclosure is a pioneering disclosure. During the test, the first loading module applies the loading force to the first static specimen, and the second loading module applies the loading force to the second static specimen. Since the first and second static specimens are directly opposite each other in the axial direction of the rotating shaft, and the loading forces applied by the first and second loading modules mutually counterbalance at least a portion thereof, it is possible to reduce the bending moment applied by the static specimens to the dynamic specimen. Therefore, the friction and wear test method in this technical solution may reduce the bending moment on the dynamic specimen, making the torque measured by the detection device more accurately reflect the actual torque of the dynamic specimen, thus reducing the error between the calculated friction coefficient and the actual friction coefficient.

Moreover, when conducting friction and wear tests under lubricated working conditions, the friction coefficient μ calculated using the friction and wear test method in this technical solution also takes into consideration the effect of lubricating oil pressure on the contact force between any static specimen and the dynamic specimen, thereby making the measured friction coefficient μ closer to the actual friction coefficient, thus reducing error.

### BRIEF DESCRIPTION OF THE DRAWINGS

FIG. 1 is a structural schematic view of a specific implementation mode in a specific embodiment 1 of the friction and wear test system of the present disclosure.

FIG. 2 is a structural schematic view after omitting dynamic specimen part from FIG. 1.

FIG. 3 is a structural schematic view of dynamic specimen part in FIG. 1.

FIG. 4 is a structural schematic view of half of the U-shaped base in FIG. 1.

FIG. 5 is a structural schematic view of the first loading piston in FIG. 1.

FIG. 6 is a structural schematic view of the first static specimen and dynamic specimen in FIG. 1.

FIG. 7 is a structural schematic view of the first static specimen in FIG. 6.

### DESCRIPTION OF EMBODIMENTS

To solve the problems in the background technology, the core inventive concept of the present disclosure is: utilizing two static specimens to apply two forces to the dynamic specimen that mutually counterbalance at least a portion thereof, thereby reducing the total bending moment applied by the static specimens to the dynamic specimen, making the torque measured by the detection device more accurately reflect the actual torque of the dynamic specimen, and reducing the error between the calculated friction coefficient and the actual friction coefficient.

The following is a further detailed description of the present disclosure in conjunction with embodiments.

Specific embodiment 1 of the friction and wear test system provided by the present disclosure is described as follows.

The purpose of this embodiment is to provide a friction and wear test system that completely eliminates the bending moment on the dynamic specimen. In this embodiment, the rotating shaft extends horizontally in the front-rear direction, and the loading forces applied by each loading module are of the same magnitude.

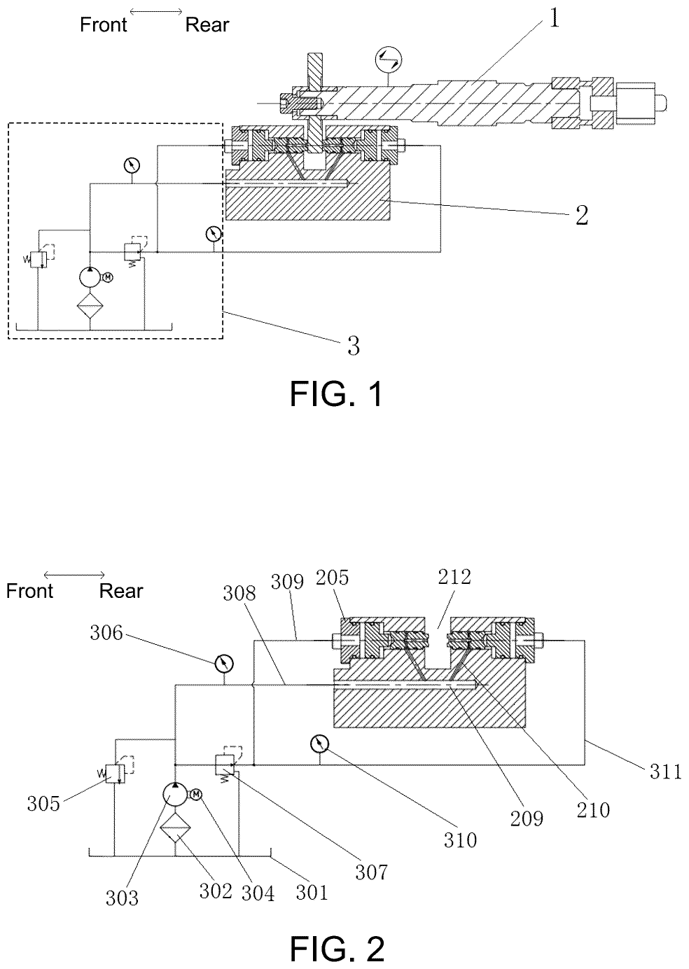

As shown in FIG. 1, the friction and wear test system is mainly divided into a dynamic specimen part 1 related to the dynamic specimen 106, a static specimen part 2 related to the static specimen, and other parts.

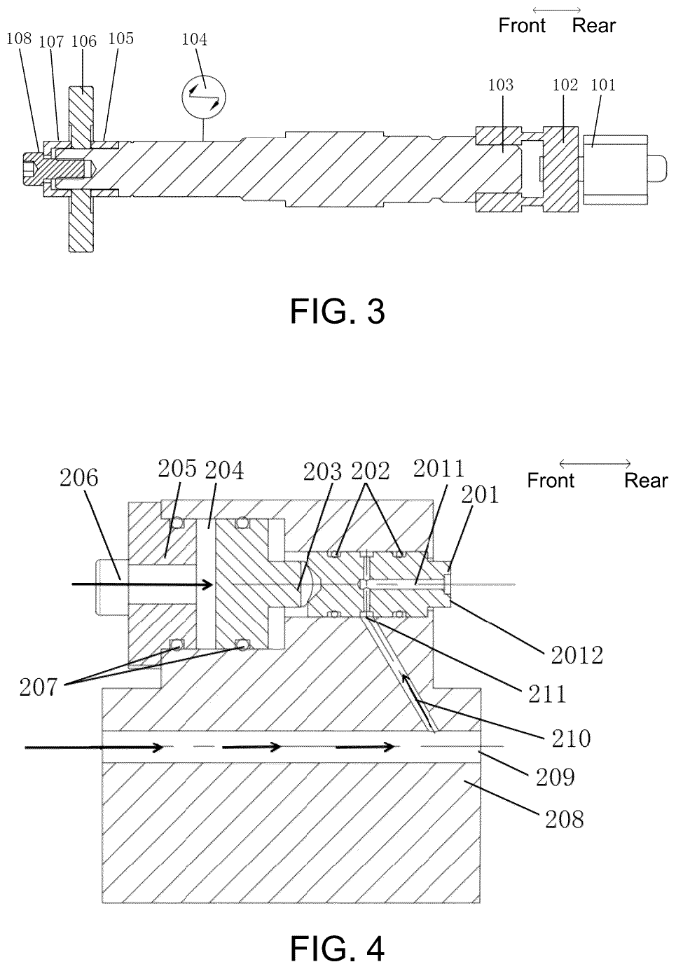

As shown in FIG. 1 to FIG. 7, the friction and wear test system specifically includes a rotating power source 101, a rotating shaft 103 driven by the rotating power source 101 with its axis extending horizontally in the front-rear direction, a coupling 102 connecting the rotating power source 101 and the rotating shaft 103, a detection device 104 for measuring a torque of the rotating shaft 103, a dynamic specimen mounting structure disposed on the rotating shaft 103 and used for mounting a dynamic specimen 106 so that the dynamic specimen 106 rotates with the rotating shaft 103, a first static specimen mounting structure for horizontally mounting a first static specimen 201, a first loading module for applying a preset loading force backward to the first static specimen 201 during the test, a second static specimen mounting structure for horizontally mounting a second static specimen and arranged directly opposite to the first static specimen mounting structure in a front-rear direction, as well as a second loading module for applying a preset loading force forward to the second static specimen during the test. The magnitudes of the preset loading forces applied by the first and second loading modules are the same. The rotating power source 101 may be a rotary motor, a rotating cylinder, or other commonly used rotating power source 101; the detection device 104 may be a torque-speed detection meter, a torque sensor, or other commonly used detection device 104 for measuring torque.

As a specific implementation mode, as shown in FIG. 1 to FIG. 7, the dynamic specimen mounting structure includes an adjustment bolt 108, a second adjustment sleeve 105 disposed around the rotating shaft 103, and a first adjustment sleeve 107 disposed around one end of the rotating shaft 103 away from the rotating power source 101. An end surface of the second adjustment sleeve 105 close to the first adjustment sleeve 107 and an end surface of the first adjustment sleeve 107 close to the second adjustment sleeve 105 both constitute clamping surfaces for holding the dynamic specimen 106. The adjustment bolt 108 has a pressing surface for pressing against one end of the first adjustment sleeve 107 away from the second adjustment sleeve 105. The adjustment bolt 108 is threaded with the rotating shaft 103 to make the clamping structure suitable for dynamic specimens 106 with different thicknesses in the front-rear direction. Of course, in other specific implementation modes, referring to FIG. 1 to FIG. 7, both the first and second adjustment sleeves may be threaded with the rotating shaft 103; or, referring to the patent with publication number CN118032324B, the dynamic specimen mounting structure may be a three-jaw chuck. In this embodiment, no limitation is imposed on the specific structure of the dynamic specimen mounting structure, as long as the dynamic specimen mounting structure is able to mount the dynamic specimen 106 and make the dynamic specimen 106 rotate with the rotating shaft 103.

As a specific implementation mode, as shown in FIG. 1 to FIG. 7, the first and second loading modules are hydraulic loading modules. However, in other specific implementation modes, the first and second loading modules may also be direct-acting electric cylinders or direct-acting pneumatic cylinders and other equipment. In this embodiment, no limitation is imposed on the structure of the first and second loading modules, as long as the first and second loading modules are able to push the corresponding static specimens, so that the corresponding static specimens press against the dynamic specimen 106 according to the preset loading force.

As a specific implementation mode, as shown in FIG. 1 to FIG. 7, the static specimen mounting structure is a piston bore, and the static specimen and a bore wall of the piston bore are slidably fitted along the front-rear direction. However, in other specific implementation modes, referring to the patent with publication number CN118032324B, the static specimen mounting structure may be a static specimen mounting base, with the static specimen fixedly mounted on the static specimen mounting base, and the loading module pushes the static specimen mounting base to move, so that the static specimen is able to move along the first direction and the second direction. In this embodiment, no limitation is imposed on the specific structure of the static specimen mounting structure, as long as the static specimen mounting structure is able to mount the static specimen and make the static specimen move along the front-rear direction under the driving of the loading module, and no limitation is imposed on whether the static specimen mounting structure moves or not.

During the test, the dynamic specimen mounting structure is utilized first to mount the dynamic specimen 106 on the rotating shaft 103, and the first and second static specimen mounting structures are utilized to mount the first and second static specimens. Afterwards, the first loading module applies a backward loading force to the first static specimen 201, and the second loading module applies a forward loading force to the second static specimen. Since the first and second static specimen mounting structures are arranged directly opposite to each other in the front-rear direction, and the magnitudes of the loading forces applied by the first and second loading modules are the same, the force applied by the first static specimen 201 to the dynamic specimen 106 and the force applied by the second static specimen to the dynamic specimen 106 constitute a force couple relationship, thereby avoiding the static specimens applying bending moment to the dynamic specimen 106. In the meantime, the axis of rotation of the dynamic specimen 106 extends horizontally, which may prevent the gravity of the dynamic specimen 106 itself from applying bending moment to the dynamic specimen 106. Therefore, the friction and wear test system in this technical solution may prevent the dynamic specimen 106 from being subjected to bending moment, making the torque measured by the detection device 104 more accurately reflect the actual torque of the dynamic specimen 106, thus reducing the error between the calculated friction coefficient and the actual friction coefficient.

To simplify the structure, as a specific implementation mode, as shown in FIG. 1 to FIG. 7, the friction and wear test system includes a U-shaped base 208. The U-shaped base 208 includes a connection part and a first mounting part and a second mounting part located at the front and rear sides of the connection part respectively. A clearance space 212 is formed between the first mounting part and the second mounting part for avoiding the dynamic specimen 106 during use. The first static specimen mounting structure is a first piston bore disposed on the first mounting part and extending along the front-rear direction, and the second static specimen mounting structure is a second piston bore disposed on the second mounting part and extending along the front-rear direction (i.e., each piston bore is parallel to the rotating shaft). The dimensions of each piston bore are used to match with the corresponding static specimen, so that each piston bore is in guided moving fit with the corresponding static specimen. Two static specimens may be mounted through one U-shaped base 208, and each piston bore is in guided moving fit with the corresponding static specimen, the structure is simple, and it is convenient for the static specimen to move along the front-rear direction.

To conveniently adjust the loading force applied by the loading module, as a specific implementation mode, as shown in FIG. 1 to FIG. 7, the first loading module includes a hydraulic station 3, a first piston chamber 204 disposed on the first mounting part, a first loading piston 203 located in the first piston chamber 204 and used to press against the first static specimen 201 backward, as well as a first loading pipeline 309 connecting the hydraulic station 3 with the first piston chamber 204. The connection point between the first loading pipeline 309 and the first piston chamber 204 is located at the front side of the first loading piston 203. The second loading module includes a hydraulic station 3, a second piston chamber disposed on the second mounting part, a second loading piston located in the second piston chamber and used to press against the second static specimen forward, as well as a second loading pipeline 311 connecting the hydraulic station 3 with the second piston chamber. The connection point between the second loading pipeline 311 and the second piston chamber is located at the rear side of the second loading piston, the structure is simple. By using the hydraulic station 3 and the loading pipeline, it is possible to conveniently adjust the force of the piston pressing against the static specimen, thereby conveniently adjusting the magnitude of the loading force. The first loading module and the second loading module may share one hydraulic station 3, or may each be provided with an independent hydraulic station. One end of the loading piston that presses against the static specimen has a pressure ball head to increase the contact area between the loading piston and the static specimen.

When the first loading module and the second loading module share one hydraulic station 3, the first loading pipeline and the second loading pipeline are connected in parallel to the same hydraulic pipeline of the hydraulic station, thereby ensuring that the magnitude of the loading force applied by the first loading module and the second loading module is always the same.

Of course, in other specific implementation modes, with reference to FIG. 1 to FIG. 7 and the patent with publication number CN118032324B, the first loading module may be a hydraulic loading module, and the second loading module may include a direct-acting electric cylinder. The output end of the direct-acting electric cylinder is pressed against the static specimen mounting base, and the second static specimen is mounted on the static specimen mounting base. The static specimen mounting base is in guided moving fit with the ground. During use, it is necessary to control the output of the hydraulic loading module and the output of the direct-acting electric cylinder to ensure that the magnitude of the loading force output by each loading module is the same.

Specifically, as shown in FIG. 1 to FIG. 2, the hydraulic station 3 includes a fuel tank 301, a filter 302, a gear pump 303, a drive motor 304 that drives the gear pump 303 to work, an overflow valve 305, and a pressure reducing valve 307 for stabilizing the loading force. The first loading pipeline 309 and the second loading pipeline 311 are connected in parallel to ensure that the magnitude of the loading force output by each loading module is always the same. A loading pressure gauge 310 for measuring the loading force is disposed on one of the loading pipelines. The magnitude of the loading force may be adjusted through the pressure reducing valve 307.

In order to conveniently repair the piston, as a specific implementation mode, as shown in FIG. 1 to FIG. 7, a first cap 205 for sealing the first piston chamber 204 is disposed on one side of the first piston chamber 204. The first cap 205 is detachably connected with the first piston chamber 204, and the dimension of the first cap 205 is compatible with the dimension of the first loading piston 203. A second cap for sealing the second piston chamber is disposed on one side of the second piston chamber. The second cap is detachably connected with the second piston chamber, and the dimension of the second cap is compatible with the dimension of the second loading piston. A second seal ring 207 is disposed between the cap and the piston chamber, and a second seal ring 207 is also disposed between the piston and the piston chamber to ensure the sealing of the piston chamber. During use, the cap has a corresponding inlet 206, and the liquid enters the piston chamber through the cap. The corresponding cap may be removed to conveniently replace the piston and the second seal ring 207.

However, in other specific implementation modes, with reference to FIG. 1 to FIG. 7, after disposing the piston in the piston chamber, a plug head that is interference fitted with the base may also be set to seal the piston chamber, and a flow guiding hole with a dimension smaller than that of the piston may be opened on the base. The first loading pipeline 309 communicates with the piston chamber through the flow guiding hole. No seal ring needs to be disposed between the plug head and the piston chamber. After the piston is damaged, a new base may be directly replaced. Of course, it is possible to only dispose the first cap 205 on the base, or only dispose the second cap on the base.

In order to test the friction coefficient μ of the static specimen and dynamic specimen 106 under lubricated working conditions, as a specific implementation mode, as shown in FIG. 1 to FIG. 7, the hydraulic medium flowing in the hydraulic station 3 and corresponding loading pipeline is lubricating oil. The hydraulic station 3 is connected with a lubricating oil supply pipeline 308. The corresponding base is further provided with a lubricating oil supply channel, which includes a lubricating oil supply main line 209, a first lubricating oil supply branch line communicating with the first piston bore, and a second lubricating oil supply branch line communicating with the second piston bore. Each lubricating oil supply branch line 210 has an oil outlet 211 communicating with the corresponding piston bore. The lubricating oil supply pipeline 308 communicates with the lubricating oil supply main line 209 to supply lubricating oil with preset pressure to each static specimen during the test. Each piston bore is provided with a first seal structure and a second seal structure that are compatible with the corresponding static specimen. Each oil outlet 211 is located between the corresponding first seal structure and second seal structure. Through the hydraulic station 3 and the lubricating oil supply channel, lubricating oil with preset pressure is provided to the static specimen in each piston bore. The lubricating oil flows through the specimen oil channel 2011 of the static specimen to the space between the static specimen and the dynamic specimen 106, with a simple structure. Under the circumstances, the hydraulic station 3 and the lubricating oil pressure gauge 306 constitute a lubricating oil supply module. In the hydraulic station 3 shown in FIG. 1 to FIG. 2, there is no pressure reducing valve 307 disposed on the lubricating oil supply pipeline 308, and the lubricating oil in the lubricating oil supply pipeline 308 is maintained at a preset pressure through the overflow valve 305. However, in other specific implementation modes, a pressure reducing valve 307 may also be disposed in the lubricating oil supply pipeline 308.

As shown in FIG. 4, two first seal rings 202 are compressed between the static specimen and the bore wall of the piston bore. The oil outlet 211 is located between the two first seal rings 202. A part of the bore wall of the piston bore in contact with the first seal ring 202 constitutes the corresponding seal structure. The static specimen and the first seal ring 202 constitute the corresponding piston structure. Of course, a mounting groove for mounting the first seal ring 202 may also be disposed on the bore wall of the piston bore, and the mounting groove constitutes the corresponding seal structure.

Of course, in other specific implementation modes, referring to FIG. 1 to FIG. 7, a separate lubricating oil supply station may also be set up. The lubricating oil supply station serves as a lubricating oil supply module. The lubricating oil supply channel includes an oil outlet 211 communicating with the first piston bore and the second piston bore to supply oil to the first static specimen 201 and the second static specimen during the test, as well as an oil inlet for communicating with the lubricating oil supply module during the test. During the test, the lubricating oil supply module is utilized to separately supply lubricating oil with preset pressure to the lubricating oil supply channel. Alternatively, referring to the patent with publication number CN118032324B, when the static specimen is fixedly mounted on the mounting base, oil may be supplied to the static specimen through the lubricating oil supply device in this existing patent mentioned above.

When using the friction and wear test system in this embodiment to test the friction coefficient, the following steps may be performed.

Step S1. Mounting the static specimen and dynamic specimen 106;

Step S2. The loading module is utilized to make the friction surface 2012 of the static specimen press against the dynamic specimen 106 under the action of the preset loading force;

Step S3. The type of test to be conducted is determined. If a friction and wear test under non-lubricated working condition is to be performed, each loading module is directly utilized to make each static specimen press against the dynamic specimen 106 with the preset loading force. If a friction and wear test under lubricated working condition is to be performed, the lubricating oil supply module is utilized to provide lubricating oil with preset pressure to the static specimen;

Step S4. The rotating power source 101 and rotating shaft 103 are utilized to drive the dynamic specimen 106 to rotate for a preset number of turns.

After the test is finished, the friction coefficient may be calculated based on the test data. The calculation of the friction coefficient may be performed through the friction and wear test method provided below in the present disclosure, or may refer to the calculation method provided in the patent with publication number CN118032324B.

In the calculation method provided in the patent with publication number

$$μ ( ω ) = \frac{{M}_{f} - {M}_{0}}{{R}_{s} F} ,$$

where: F is the axial loading force applied by a single loading module; M_{f} is the torque of the rotating shaft 103 measured by the speed-torque sensor; ω is the rotational speed of the rotating shaft 103; Rₛ is the equivalent friction radius of the friction pair; and M₀ is the torque of the rotating shaft 103 measured by the speed-torque sensor when the axial loading force F is 0. When using the friction and wear test system in the present disclosure to measure the friction coefficient, since there are two static specimens simultaneously pressing against the dynamic specimen 106, the friction coefficient should be divided by 2 based on the existing friction coefficient, that is, the friction coefficient is

$$μ ( ω ) = \frac{{M}_{f} - {M}_{0}}{2 {R}_{s} F} .$$

Specific embodiment 2 of the friction and wear test system provided by the present disclosure is described as follows.

The purpose of this embodiment is to provide a friction and wear test system with a different base.

Referring to FIG. 1 to FIG. 7, the main difference between this embodiment and specific embodiment 1 is: in specific embodiment 1, the base is a U-shaped base 208, the U-shaped base 208 has a first piston bore and a second piston bore, and the lubricating oil supply channel includes a lubricating oil supply main line 209 and a lubricating oil supply branch line 210. In comparison, in this embodiment, the friction and wear test system includes a first base and a second base arranged in a front-to-back configuration, the part between the first base and the second base forms a clearance space 212 for avoiding the dynamic specimen 106 during use, the first base is provided with a first mounting part, the second base is provided with a second mounting part, the first static specimen mounting structure is a first piston bore disposed on the first mounting part and extending in the front-rear direction, the second static specimen mounting structure is a second piston bore disposed on the second mounting part and extending in the front-rear direction, and each base is provided with a lubricating oil supply channel.

Referring to FIG. 1 to FIG. 7, in other specific implementations, the base may still be a U-shaped base 208, where the U-shaped base 208 has two independent lubricating oil supply channels, and each lubricating oil supply channel is connected to a different piston bore.

Specific embodiment 3 of the friction and wear test system provided by the present disclosure is described as follows.

The purpose of this embodiment is to provide a friction and wear test system with a rotating shaft extending in a different direction.

The main difference between this embodiment and specific embodiment 1 is: in specific embodiment 1, the rotating shaft extends horizontally in the front-rear direction, while in this embodiment, the rotating shaft extends in the vertical direction. Of course, in other specific implementations, the rotating shaft may also be disposed in an inclined manner. The extending direction of the rotating shaft determines the bending moment applied to the dynamic specimen by the weight of the dynamic specimen itself.

Under the circumstances, when calculating the friction coefficient μ, the formula

$$μ ( ω ) = \frac{{M}_{f} - {M}_{0}}{2 {R}_{s} F}$$

may be used to eliminate the error of the bending moment applied to the dynamic specimen by the weight of the dynamic specimen itself.

In the formula, F is the axial loading force applied by the linear loading cylinder; M_{f} is the torque of the rotating shaft 103 measured by the speed-torque sensor; ω is the rotational speed of the rotating shaft 103; Rₛ is the equivalent friction radius of the friction pair; M₀ is the torque of the rotating shaft 103 measured by the speed-torque sensor when the axial loading force F is 0.

Specific embodiment 4 of the friction and wear test system provided by the present disclosure is described as follows.

The purpose of this embodiment is to provide a friction and wear test system with each loading module having different loading forces.

The main difference between this embodiment and specific embodiment 1 is: in specific embodiment 1, the magnitude of the loading force applied by each loading module is the same, while in this embodiment, the magnitude of the loading force applied by each loading module is different, so that during the test, the force applied by the second static specimen to the dynamic specimen and the force applied by the first static specimen to the dynamic specimen mutually counterbalance at least a portion thereof, thereby reducing error.

Under the circumstances, when calculating the friction coefficient μ, it may be set that F=F₁+F₂, where F₁ is the preset loading force pointing at the dynamic specimen and applied to the first static specimen by the first loading module, F₂ is the preset loading force pointing at the dynamic specimen and applied to the second static specimen by the second loading module.

Specific embodiment of the friction and wear test method provided by the present disclosure is described as follows.

In the test method of the patent with publication number CN118032324B, constant pressure lubrication is employed (i.e., the pressure of the lubricating oil is equal to atmospheric pressure), therefore the influence of lubricating oil pressure does not need to be taken into consideration in the calculation of the friction coefficient μ(ω), and the friction coefficient μ(ω) may be directly calculated using the axial loading force F applied by the linear loading cylinder. However, in the actual working conditions of hydraulic pumps, the pressure of the lubricating oil is much higher than atmospheric pressure, so the influence of lubricating oil pressure on the friction coefficient μ(ω) cannot be ignored.

To overcome the above deficiencies, a new friction and wear test method is provided in the present disclosure. Referring to FIG. 1 to FIG. 7, the friction and wear test method in the present disclosure is described as follows.

During the test, rotating shaft 103 is employed to drive the dynamic specimen 106 to rotate, and the first static specimen 201 and the second static specimen that are directly opposite to each other in the axial direction of the rotating shaft are employed to clamp the dynamic specimen 106. The first static specimen 201 is applied with a preset loading force F₁ pointing at the dynamic specimen by the first loading module, the second static specimen is applied with a preset loading force F₂ pointing at the dynamic specimen by the second loading module, and the preset loading forces applied by the first and second loading modules mutually counterbalance at least a portion thereof.

When the rotating shaft 103 extends horizontally, the friction coefficient is calculated as

$$μ = \frac{T}{R F} ,$$

where: T is the torque of the rotating shaft, F is the sum of the contact forces between each static specimen and the dynamic specimen 106, R is the distance from the center of the annular friction surface 2012 where any static specimen contacts the dynamic specimen 106 to the axis of the dynamic specimen 106.

When the rotating shaft 103 does not extend horizontally, the friction coefficient is calculated as

$$μ = \frac{T - {T}_{0}}{R F} ,$$

where: T₀ is the torque of the rotating shaft measured by the speed-torque sensor when F is 0.

When conducting friction and wear tests under non-lubricated working conditions,

$$F = {F}_{1} + {F}_{2} .$$

When conducting friction and wear tests under non-lubricated working conditions, lubricating oil supply module is utilized to provide lubricating oil with preset pressure to the static specimen, F=F₁+F₂−F₃−F₄, where: F₃ and F₄ are the forces applied to the static specimen by the lubricating oil located between each static specimen and the dynamic specimen 106.

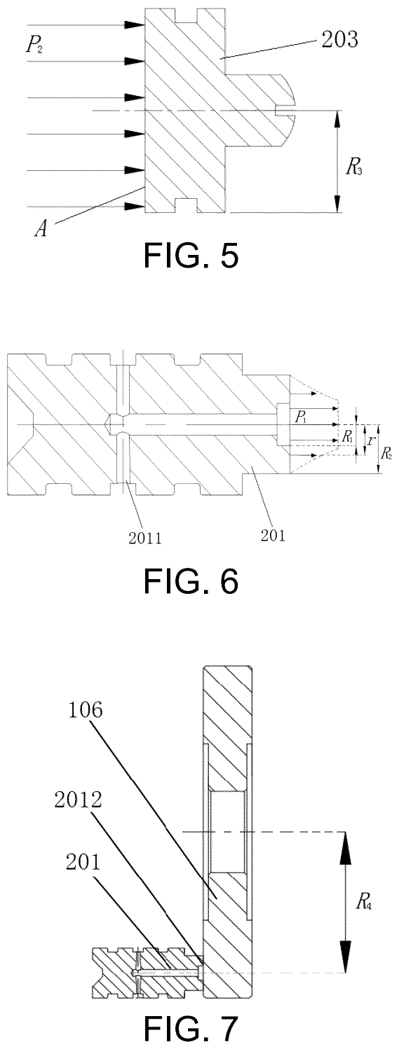

Referring to FIG. 5, the loading force F₁ applied by the loading piston to the static specimen is F₁=πAP₂, where: A is the area where the loading piston and the liquid in the piston chamber contact each other, and P₂ is the pressure of the liquid in the piston chamber. Similarly, F₂ may be calculated by analogy.

Referring to FIG. 6,

$${F}_{3} = {\int }_{{R}_{2}}^{{R}_{1}} 2 π {p}_{1} \frac{ln \frac{{R}_{1}}{r}}{ln \frac{{R}_{1}}{{R}_{2}}} r d r ,$$

where: p₁ is the pressure of the lubricating oil, R₁ is the outer diameter of the annular friction surface 2012 of the static specimen, R₂ is the inner diameter of the annular friction surface 2012 of the static specimen, R₁≤r≤R₂. Similarly, F₄ may be calculated by analogy.

In the optimal friction and wear test method, the rotating shaft extends horizontally, the magnitude of the preset loading force applied by each loading module is the same, and the pressure of the lubricating oil between each static specimen and the dynamic specimen is the same.

Under the circumstances, after calculating the friction coefficient, the wear rate w of each specimen may also be calculated and compared,

$$w = \frac{2 Δ m}{ρ FnR} ,$$

where Δm is the wear mass of each specimen, ρ is the density of each specimen, n is the number of rotations of the dynamic specimen 106 or the rotating shaft 103.

During the test, the contact stress between each static specimen and the dynamic specimen 106 is calculated as

$$σ = \frac{F}{2 S} ,$$

where: S is the area of the friction surface 2012 where any static specimen contacts the dynamic specimen 106. The contact stress between the static specimen and the dynamic specimen 106 may be changed by changing the static specimens with different areas of the friction surface 2012, thereby testing the friction coefficient μ when the contact stress between the static specimen and the dynamic specimen 106 is different.

Since the contact surface between the static specimen and the dynamic specimen 106 is an annular surface,

$$S = π ( {R}_{1}^{2} - {R}_{2}^{2} ) ,$$

by replacing static specimens with different outer diameter R₁ and/or inner diameter R₂, the contact stress between the static specimen and the dynamic specimen 106 may be changed. Alternatively, a hydraulic pressure in the piston chamber may be regulated through the pressure reducing valve to change F₁ and F₂, thereby changing a magnitude of F, and consequently adjusting the contact stress between each of the static specimen and the dynamic specimen 106 to achieve the same static specimen, thus realizing a testing of the friction coefficient between the same static specimen and the dynamic specimen under different contact stress conditions through a hydraulic pressure adjustment in the piston chamber. Both of the aforementioned different methods may conveniently realize the testing of friction coefficients under different contact stress conditions.

It should be specifically pointed out that, when the rotating shaft extends horizontally,

$$μ = \frac{T - {T}_{0}}{R F} = μ = \frac{T}{R F} + C ,$$

where C is a constant. Therefore, adding a constant C on the basis of friction coefficient

$$μ = \frac{T}{R F}$$

is also a friction coefficient calculated through

$$μ = \frac{T}{R F} ,$$

which is also within the scope to be protected by the present disclosure.

Finally, it should be pointed out that the above description is only preferred embodiments of the disclosure and is not intended to limit the disclosure. Although the disclosure has been described in detail with reference to the above-mentioned examples, it is still possible for those skilled in the art to modify the technical means described in the above-mentioned examples without creative work, or to make equal substitutions of some or all of the technical configurations therein. Any modifications, equivalent substitutions, and improvements etc. made within the spirit and principle of the present disclosure shall fall within the protection scope of the present disclosure.

What is claimed is:

1. A friction and wear test system, comprising a rotating shaft, a dynamic specimen mounting structure disposed on the rotating shaft and configured for mounting a dynamic specimen to make the dynamic specimen rotate with the rotating shaft, a first static specimen mounting structure for mounting a first static specimen, and a first loading module for applying a preset loading force pointing at the dynamic specimen to the first static specimen during a test, wherein the friction and wear test system further comprises a second static specimen mounting structure for mounting a second static specimen and arranged directly opposite to the first static specimen mounting structure in an axial direction of the rotating shaft, the second static specimen mounting structure is configured with a second loading module for applying a preset loading force pointing at the dynamic specimen to the second static specimen during the test, so as to at least partially counterbalance a force loaded by the first static specimen on the dynamic specimen during the test.

2. The friction and wear test system according to claim 1, wherein the rotating shaft extends horizontally in a front-rear direction, and magnitudes of the preset loading forces applied by the first loading module and the second loading module are the same.

3. The friction and wear test system according to claim 1, wherein the friction and wear test system comprises a U-shaped base, the U-shaped base comprises a connecting part and a first mounting part and a second mounting part located on both sides of the connecting part, a clearance space is formed between the first mounting part and the second mounting part for avoiding the dynamic specimen during use, the first static specimen mounting structure is a first piston bore disposed on the first mounting part and parallel to the rotating shaft, the second static specimen mounting structure is a second piston bore disposed on the second mounting part and parallel to the rotating shaft, a dimension of each piston bore is designed to match with a corresponding static specimen, so that each of the piston bore is in guided moving fit with the corresponding static specimen.

4. The friction and wear test system according to claim 2, wherein the friction and wear test system comprises a U-shaped base, the U-shaped base comprises a connecting part and a first mounting part and a second mounting part located on both sides of the connecting part, a clearance space is formed between the first mounting part and the second mounting part for avoiding the dynamic specimen during use, the first static specimen mounting structure is a first piston bore disposed on the first mounting part and parallel to the rotating shaft, the second static specimen mounting structure is a second piston bore disposed on the second mounting part and parallel to the rotating shaft, a dimension of each piston bore is designed to match with a corresponding static specimen, so that each of the piston bore is in guided moving fit with the corresponding static specimen.

5. The friction and wear test system according to claim 3, wherein the first loading module comprises a hydraulic station, a first piston chamber disposed on the first mounting part, a first loading piston located in the first piston chamber and configured for pressing against the first static specimen, and a first loading pipeline connecting the hydraulic station with the first piston chamber, wherein a connection point between the first loading pipeline and the first piston chamber is located on one side of the first loading piston away from the first piston bore.

6. The friction and wear test system according to claim 5, wherein the second loading module comprises a second piston chamber disposed on a second mounting part, a second loading piston located in the second piston chamber and configured for pressing against the second static specimen, and a second loading pipeline connecting the hydraulic station with the second piston chamber, wherein a connection point between the second loading pipeline and the second piston chamber is located on one side of the second loading piston away from the second piston bore, the first loading module and the second loading module share one of the hydraulic station, and the first loading pipeline and the second loading pipeline are connected in parallel to a same hydraulic pipeline of the hydraulic station, or, the first loading module and the second loading module are each provided with one of the independent hydraulic station.

7. The friction and wear test system according to claim 6, wherein a hydraulic medium flowing in the hydraulic station and a corresponding loading pipeline is lubricating oil, the hydraulic station is connected with a lubricating oil supply pipeline, the U-shaped base is further provided with a lubricating oil supply channel, the lubricating oil supply channel comprises a lubricating oil supply main line, a first lubricating oil supply branch line connected to the first piston bore and a second lubricating oil supply branch line connected to the second piston bore, each lubricating oil supply branch line has an oil outlet connected to a corresponding piston bore, the lubricating oil supply pipeline is connected to the lubricating oil supply main line to supply the lubricating oil with a preset pressure to each of the static specimen during the test, each of the piston bore is provided with a first seal structure and a second seal structure adapted to the corresponding static specimen, and each of the oil outlet is located between the corresponding first seal structure and the corresponding second seal structure.

8. A friction and wear test method, wherein during a test, a rotating shaft is utilized to drive a dynamic specimen to rotate, and a first static specimen and a second static specimen that are directly opposite each other in an axial direction of the rotating shaft are utilized to clamp the dynamic specimen, the first static specimen is applied with a preset loading force F₁ pointing at the dynamic specimen by a first loading module, the second static specimen is applied with a preset loading force F₂ pointing at the dynamic specimen by a second loading module, and the preset loading forces applied by the first loading module and the second loading module mutually counterbalance at least a portion thereof;
wherein when the rotating shaft extends horizontally, a friction coefficient is calculated as
$$μ = \frac{T}{R F} ,$$
where: T is a torque of the rotating shaft, F is a sum of contact forces between each static specimen and the dynamic specimen, R is a distance from a center of an annular friction surface where any of the static specimen contacts the dynamic specimen to an axis of the dynamic specimen;
when the rotating shaft does not extend horizontally, the friction coefficient is calculated as
$$μ = \frac{T - {T}_{0}}{R F} ,$$
where: T₀ is a torque of the rotating shaft measured by a speed-torque sensor when F is 0;
when conducting friction and wear tests under non-lubricated working conditions, F=F₁+F₂;
when conducting friction and wear tests under non-lubricated working conditions, a lubricating oil supply module is utilized to provide lubricating oil with a preset pressure to the static specimen, F=F₁+F₂−F₃−F₄, where: F₃ and F₄ are forces applied to the static specimen by the lubricating oil located between each of the static specimen and the dynamic specimen.

9. The friction and wear test method according to claim 8, wherein the rotating shaft extends horizontally, and magnitudes of the preset loading forces applied by each loading module are the same, pressures of the lubricating oil between each of the static specimen and the dynamic specimen are the same, so that F₃=F₄.

10. The friction and wear test method according to claim 9, wherein a plurality of tests are conducted using different specimens, and a wear rate w of each of the specimen is calculated,
$$w = \frac{2 Δ m}{ρ FnR} ,$$
where: Δm is a wear mass of each of the specimen, ρ is a density of each of the specimen, and n is a number of rotations of the dynamic specimen or the rotating shaft.

11. The friction and wear test method according to claim 9, wherein during the test, a contact stress between each of the static specimen and the dynamic specimen is calculated as
$$σ = \frac{F}{2 S} ,$$
where: S is an area of a friction surface where any of the static specimen contacts the dynamic specimen, the contact stress between the static specimen and the dynamic specimen is changed by changing static specimens with different areas of the friction surface, thereby testing the friction coefficient μ when the contact stress between the static specimen and the dynamic specimen is different.

12. The friction and wear test method according to claim 10, wherein during the test, a contact stress between each of the static specimen and the dynamic specimen is calculated as
$$σ = \frac{F}{2 S} ,$$
where: S is an area of a friction surface where any of the static specimen contacts the dynamic specimen, the contact stress between the static specimen and the dynamic specimen is changed by changing static specimens with different areas of the friction surface, thereby testing the friction coefficient μ when the contact stress between the static specimen and the dynamic specimen is different.

13. The friction and wear test method according to claim 8, wherein F₁ and F₂ are changed by adjusting a hydraulic pressure, thereby altering a magnitude of F and regulating a contact stress between each of the static specimen and the dynamic specimen to achieve a same static specimen, thus realizing a testing of the friction coefficient between the static specimen and the dynamic specimen under different contact stress conditions through a hydraulic pressure adjustment.
